(19) United States
(12) Patent Application Publication
(10) Pub. No.: US 2022/0272103 A1
(43) Pub. Date: Aug. 25, 2022

(54) ADAPTIVE ACCESS CONTROL TECHNOLOGY

(71) Applicant: David J. DURYEA, Smithtown, NY (US)

(72) Inventor: David J. DURYEA, Smithtown, NY (US)

(21) Appl. No.: 17/618,180

(22) PCT Filed: Jun. 15, 2020
(86) PCT No.: PCT/US2020/037776

§ 371 Date: Dec. 10, 2021

Related U.S. Application Data
(60) Provisional application No. 62/860,994, filed on Jun. 13, 2019.

(51) Int. Cl. H04L 9/40; G06F 21/62

(52) U.S. Cl. CPC H04L 63/108; G06F 21/6218

(57) ABSTRACT

A method and system for processing an access request are provided. The method includes displaying authorized resources of a user, receiving an access request for a resource based on a user selection, prompting the user to confirm the requested access for the resource, receiving a confirmation from the user for the requested access for the resource, and applying a corresponding security permission based on the received confirmation.

### PRIORITY

This application is based on and claims priority under 35 U.S.C. § 119(e) to U.S. Provisional Patent Application Serial Nos. 62/860,994, filed on Jun. 13, 2019, in the United States Patent and Trademark Office, the entire contents of which are incorporated herein by reference.

### FIELD

The present disclosure is generally related to systems and methods for controlling user access to data.

### BACKGROUND

During the early stages of computing systems, many systems were not connected through a global network or the Internet. Tools have been provided for organizations to store data, share files/folders and set predefined static permissions for users based on their account ID and/or group membership. This method has been a commonplace as ideal to define security and grant access to resources.

A systems administrator would configure permissions on shares, files and folders in that when a user logs into a system, the permissions are already defined, thus giving the user access to all approved resources concurrently whether the user required access to the resource at that time or not. The current method on how permissions are applied would be impossible for administrators to manage and change permissions throughout the day for all users. This has led to permissions being applied statically and granting access to authorized resources whether or not they are needed at the time.

### SUMMARY

According to one embodiment, a method for processing an access request includes displaying authorized resources of a user, receiving an access request for a resource based on a user selection, prompting the user to confirm the requested access for the resource, receiving a confirmation from the user for the requested access for the resource, and applying a corresponding security permission based on the received confirmation.

According to one embodiment, a system for processing an access request includes a memory and a processor configured to display authorized resources of a user, receive an access request for a resource based on a user selection, prompt the user to confirm the requested access for the resource, receive a confirmation from the user for the requested access for the resource, and apply a corresponding security permission based on the received confirmation.

According to one embodiment, a method for archiving and restoring resources includes receiving an archiving or restoring request of a resource from a user, determining whether the resource is being accessed or is granted access to another user, and archiving or restoring the resource when the resource is not being accessed and has not been granted access to another user.

According to one embodiment, a method for real-time data hold (RTDH) of a resource includes configuring a resource for RTDH, determining that a user has modified or deleted the resource configured for RTDH and storing a prior version of the modified or deleted resource.

### BRIEF DESCRIPTION OF THE DRAWINGS

The above and other aspects, features, and advantages of certain embodiments of the present disclosure will be more apparent from the following detailed description, taken in conjunction with the accompanying drawings, in which:

FIG. 1 illustrates a flowchart of steps for an access request process, according to an embodiment;

FIG. 2 illustrates a diagram of a displayed list of authorized resources of a user, according to an embodiment;

FIG. 3 illustrates a diagram of contents of a folder, according to an embodiment;

FIG. 4 illustrates a diagram of a user requesting access to resources, according to an embodiment;

FIG. 5 illustrates a diagram of a user requesting access to resources, according to an embodiment;

FIG. 6 illustrates a diagram of a prompt to a user, according to an embodiment;

FIG. 7 illustrates a diagram of a file explorer, according to an embodiment;

FIG. 8 illustrates a diagram of a user requesting to archive a resource, according to an embodiment;

FIG. 9 illustrates a diagram of a user requesting to restore an archived resource, according to an embodiment;

FIG. 10 illustrates a flowchart for a method for archiving resources, according to an embodiment;

FIG. 11 illustrates a flowchart for a method of restoring resources, according to an embodiment;

FIG. 12 illustrates a flowchart for real-time data hold (RTDH) management, according to an embodiment; and

FIG. 13 illustrates a block diagram of an electronic device in a network environment, according to one embodiment.

### DETAILED DESCRIPTION

Hereinafter, embodiments of the present disclosure are described in detail with reference to the accompanying drawings. It should be noted that the same elements will be designated by the same reference numerals although they are shown in different drawings. In the following description, specific details such as detailed configurations and components are merely provided to assist with the overall understanding of the embodiments of the present disclosure. Therefore, it should be apparent to those skilled in the art that various changes and modifications of the embodiments described herein may be made without departing from the scope of the present disclosure. In addition, descriptions of well-known functions and constructions are omitted for clarity and conciseness. The terms described below are terms defined in consideration of the functions in the present disclosure, and may be different according to users, intentions of the users, or customs. Therefore, the definitions of the terms should be determined based on the contents throughout this specification.

The present disclosure may have various modifications and various embodiments, among which embodiments are described below in detail with reference to the accompanying drawings. However, it should be understood that the present disclosure is not limited to the embodiments, but includes all modifications, equivalents, and alternatives within the scope of the present disclosure.

Although the terms including an ordinal number such as first, second, etc. may be used for describing various elements, the structural elements are not restricted by the terms. The terms are only used to distinguish one element from another element. For example, without departing from the scope of the present disclosure, a first structural element may be referred to as a second structural element. Similarly, the second structural element may also be referred to as the first structural element. As used herein, the term “and/or” includes any and all combinations of one or more associated items.

The terms used herein are merely used to describe various embodiments of the present disclosure but are not intended to limit the present disclosure. Singular forms are intended to include plural forms unless the context clearly indicates otherwise. In the present disclosure, it should be understood that the terms “include” or “have” indicate existence of a feature, a number, a step, an operation, a structural element, parts, or a combination thereof, and do not exclude the existence or probability of the addition of one or more other features, numerals, steps, operations, structural elements, parts, or combinations thereof.

Unless defined differently, all terms used herein have the same meanings as those understood by a person skilled in the art to which the present disclosure belongs. Terms such as those defined in a generally used dictionary are to be interpreted to have the same meanings as the contextual meanings in the relevant field of art, and are not to be interpreted to have ideal or excessively formal meanings unless clearly defined in the present disclosure.

The electronic device according to one embodiment may be one of various types of electronic devices. The electronic devices may include, for example, a portable communication device (e.g., a smart phone), a computer, a portable multimedia device, a portable medical device, a camera, a wearable device, or a home appliance. According to one embodiment of the disclosure, an electronic device is not limited to those described above.

The terms used in the present disclosure are not intended to limit the present disclosure but are intended to include various changes, equivalents, or replacements for a corresponding embodiment. With regard to the descriptions of the accompanying drawings, similar reference numerals may be used to refer to similar or related elements. A singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases. As used herein, terms such as “1^{st},” “2nd,” “first,” and “second” may be used to distinguish a corresponding component from another component, but are not intended to limit the components in other aspects (e.g., importance or order). It is intended that if an element (e.g., a first element) is referred to, with or without the term “operatively” or “communicatively”, as “coupled with,” “coupled to,” “connected with,” or “connected to” another element (e.g., a second element), it indicates that the element may be coupled with the other element directly (e.g., wired), wirelessly, or via a third element.

As used herein, the term “module” may include a unit implemented in hardware, software, or firmware, and may interchangeably be used with other terms, for example, “logic,” “logic block,” “part,” and “circuitry.” A module may be a single integral component, or a minimum unit or part thereof, adapted to perform one or more functions. For example, according to one embodiment, a module may be implemented in a form of an application-specific integrated circuit (ASIC).

The present system and method provides a platform that manages permissions to authorize what resources a user can have access to and then allows that user to request a token to access that resource for a predefined period of time. The present system and method may integrate into various operating systems and third-party cloud storage providers to act as a bridge between a storage systems access control and an authorized user.

The main storage systems permissions may be limited to a single or multiple service account(s) which may then be defined as an authorized service account in the system controller. The service accounts may only require to be limited user accounts and do not need to be a systems administrative account. The service account(s) may then be given permissions to shared resource folders that permit the system to modify permissions of that resource remotely. The system may then manage all authorized permissions to grant/revoke permissions of filesystem resources.

Detailed file system permissions for users and/or groups may be defined on the system by a systems administrator. The systems administrator may define what permissions a user can potentially have on a given file system. When permissions are defined, the permissions may be logged for auditing purposes. Resources may be flagged with predefined attributes such as “Confidential”, “Requires Approval”, notifications, customized workflow, and/or other notifications. These attributes then provide further notification and/or workflow for approval by managers or folder owners if a resource is requested.

The user may also be required to select a duration of time in which they require access to a requested resource. The duration time may be configurable by resource, user, group and/or global company defaults defined by a systems administrator. If the user is permitted to access the resource, the system may then configure the permissions on the remote resource. When the duration has expired, the system may automatically revoke the user's permissions on the filesystem for that respective resource and secure it. All requests and changes may be stored in a central database for historical reporting and management. A user may also revoke their own permission to resources if they no longer require access to the respective resource.

When the system authenticates a user, they will be able to navigate through predefined resources or navigate through authorized folders they would require access. When they find the required resource, they can then request access themselves. Access will be provided immediately or until approval is provided depending on the defined attributes of the resource.

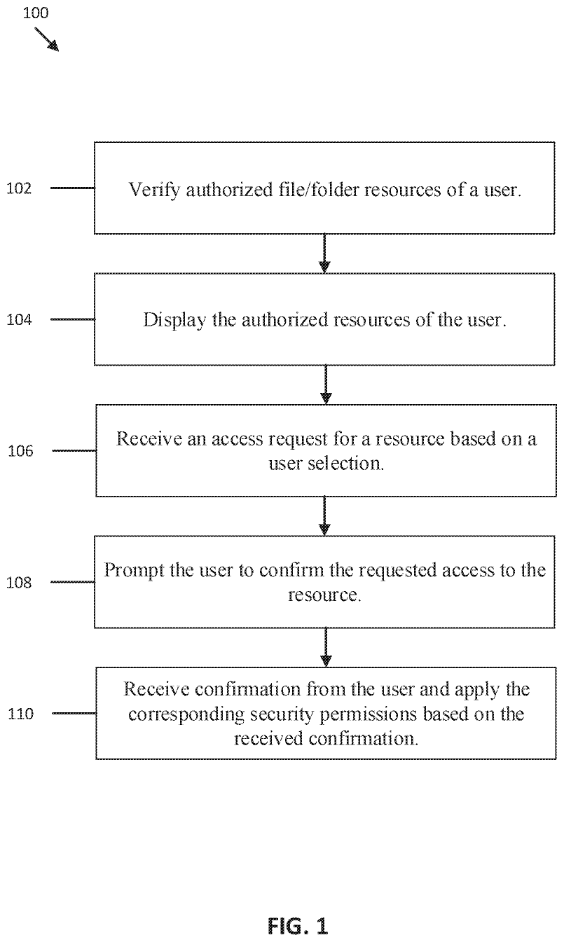

FIG. 1 illustrates a flowchart 100 of steps for an access request process, according to an embodiment. At 102, the system verifies authorized file/folder resources of a user. The authorized file/folder resources of a user may be configured based on permissions assigned to the user. As used herein, resources may refer to files, folders, data, and/or other items to which a user may request access. At 104, the system displays the authorized resources of the user.

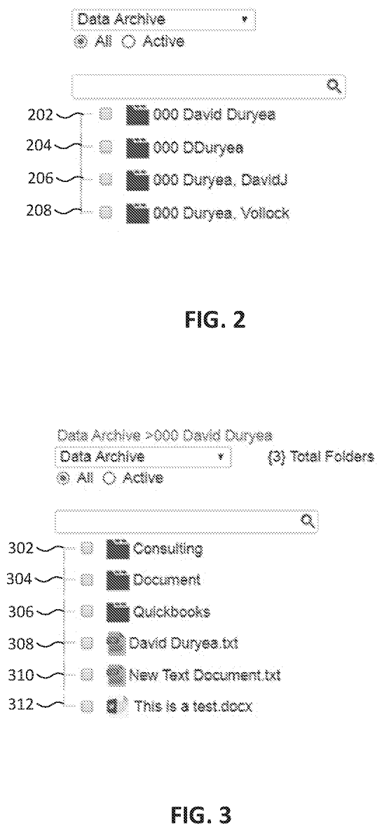

FIG. 2 illustrates a diagram of a displayed list of authorized resources of a user, according to an embodiment. For example, the authorized resources may include file folders, such as file folder 202, 204, 206 and 208. The folders may be displayed with the same parent/child relationship for which the user would browse the file system normally. The system may only display the files/folder the user is authorized. All other files/folders may not be available as the user does not have the assigned permissions. Here, although the displayed resources are authorized to the user, the user may not be able to access the authorized resources until an access request is processed by the system.

FIG. 3 illustrates a diagram of contents of a folder, according to an embodiment. For example, the contents of folder 202, including folders 302, 304 and 306, as well as documents 308, 310 and 312, are shown in FIG. 3. The system may only display the folders/files that the user has been granted prior permissions by an administrator, enabling the user to be authorized to have access. Browsing the contents through the system may or may not permit the user to view the contents of files through the portal. The user may be restricted from accessing the displayed file or folder, even though the file or folder is displayed and the user is authorized to access the file or folder.

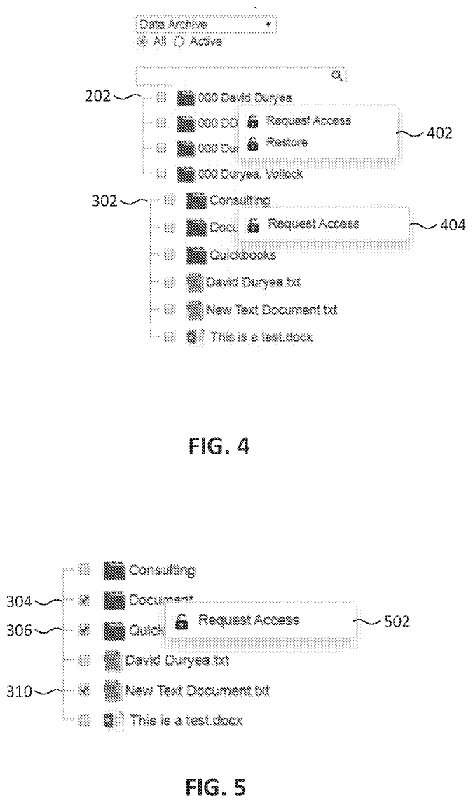

At 106, the system receives an access request for a resource based on a user selection. The system may receive an access request for a resource which a user is authorized to access. FIG. 4 illustrates a diagram of a user requesting access to resources, according to an embodiment. The system may display a selection menu for requesting access to a resource. For example, selection menu 402 may be presented to the user when requesting access to resource 202, and selection menu 404 may be presented to the user when requesting access to resource 302. The user may request access by clicking on the appropriate item within the displayed selection menu.

FIG. 5 illustrates a diagram of a user requesting access to resources, according to an embodiment. In one example, the user may select multiple files/folders and then right-click once to request access. As shown in FIG. 5, the user has selected folders 304 and 306, as well as document 310 to which to request access, and the user may then submit the request by selecting item 502 in the displayed selection menu.

The system may determine which resources to which the user is authorized to request access, and the resources to which the user is authorized to request access may be displayed. If a user is not authorized to request access to a resource, the system may not display the resource to the user. The system may permit an administrator to determine which resources to which a user is authorized to request access.

In one example, a user does not have to request access to a root folder. If a user only requires access to a child file/folder within authorized resources, then the user may only need to request access to the child file/folder. Thus, security is increased as there is no need to enable access to more files/folders than what is required at that time.

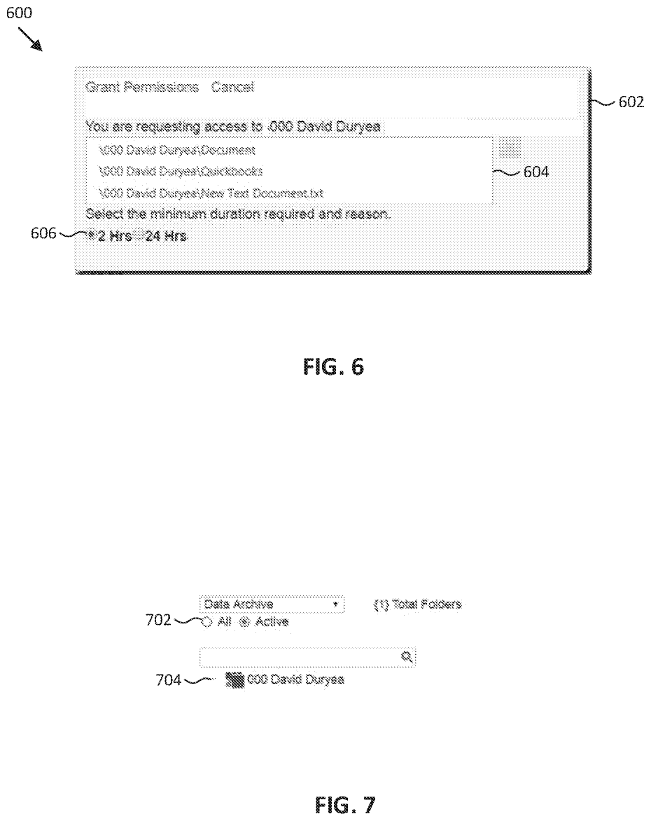

At 108, the system prompts the user to confirm the requested access to the resource. FIG. 6 illustrates a diagram of a prompt to a user, according to an embodiment. The prompt 600 may include a window 602 with a list 604 of resources to which the user requested access. The prompt 600 may also include a duration selection 606 such that the system can receive a selected access duration to the resources to which the user requested access. As shown in FIG. 6, the user may select 2 hours or 24 hours. Alternative durations may be utilized.

At 110, the system receives a confirmation from the user and applies the corresponding security permissions based on the received confirmation. The confirmation may include the resources to which the user requests access, and an access duration to those resources. FIG. 7 illustrates a diagram of a file explorer, according to an embodiment. The file explorer includes a sorting tab 702 that allows a user to sort contents by “All” or “Active”. When the active option is selected, the system displays resources to which the user has been granted access based on the resource access request. The resource, such as resource 704, may include an indication that the resource is available to access, such as an icon (e.g., an unlocked icon as shown in FIG. 7). When the access duration expires, the system revokes the user's access to the resources, and the resources are no longer “Active” in the file explorer. Additionally, a user may manually revoke access to the resource prior to the expiration of the access period by sending a request to the system to revoke access to the resource.

The present system provides the ability to define archiving settings of root folders (or resources). The system provides administrators the ability to define an archiving resource folder for each configured root folder. Archiving can be initiated manually or by configuring archiving rules that will automatically archive folders that have not been accessed (e.g., for a predetermined time period). The system can allow authorized users and groups to be permitted to archive root resources. The ability to archive may not be displayed to a user that does not have authorization to submit an archiving request.

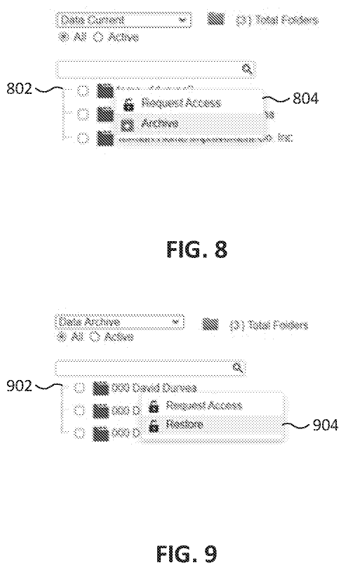

FIG. 8 illustrates a diagram of a user requesting to archive a resource, according to an embodiment. In the file explorer, a user may select a resource 802. If the user is authorized to request archiving of the resource, the system may display a selection menu 804 that allows a user to submit an archive request.

FIG. 9 illustrates a diagram of a user requesting to restore an archived resource, according to an embodiment. In the file explorer, a user may select a resource 902. If the user is authorized to request restoration of an archived resource, the system may display a selection menu 904 that allows a user to submit a restoration request. A corresponding icon may be presented in the selection menus indicating whether a resource can be archived and/or whether a resource is restorable.

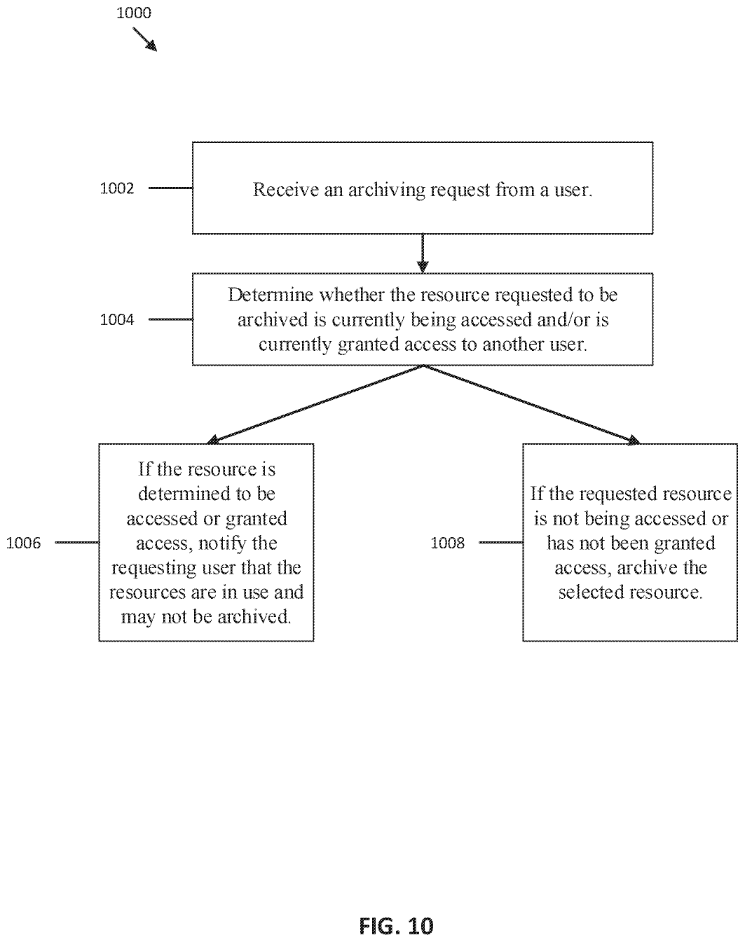

FIG. 10 illustrates a flowchart 1000 for a method for archiving resources, according to an embodiment. At 1002, the system receives an archiving request from a user. The system may have previously determined whether the user is authorized to submit an archiving request, or the system may determine after the request is received whether the user is authorized to submit an archiving request. At 1004, the system determines whether the resource requested to be archived is currently being accessed and/or is currently granted access to another user. In other words, the system determines whether the resource requested to be archived is being accessed or could possibly be accessed based on a previously granted access request. At 1006, if the resource is determined to be accessed or granted access, the system notifies the requesting user that the resource is in use and may not be archived. The system may archive a previous version of the requested resource if the resource is currently being accessed. At 1008, if the resource requested to be archived is not being accessed or has not been granted access, the system archives the selected resource. The system may archive the selected resource to a pre-defined archive data volume.

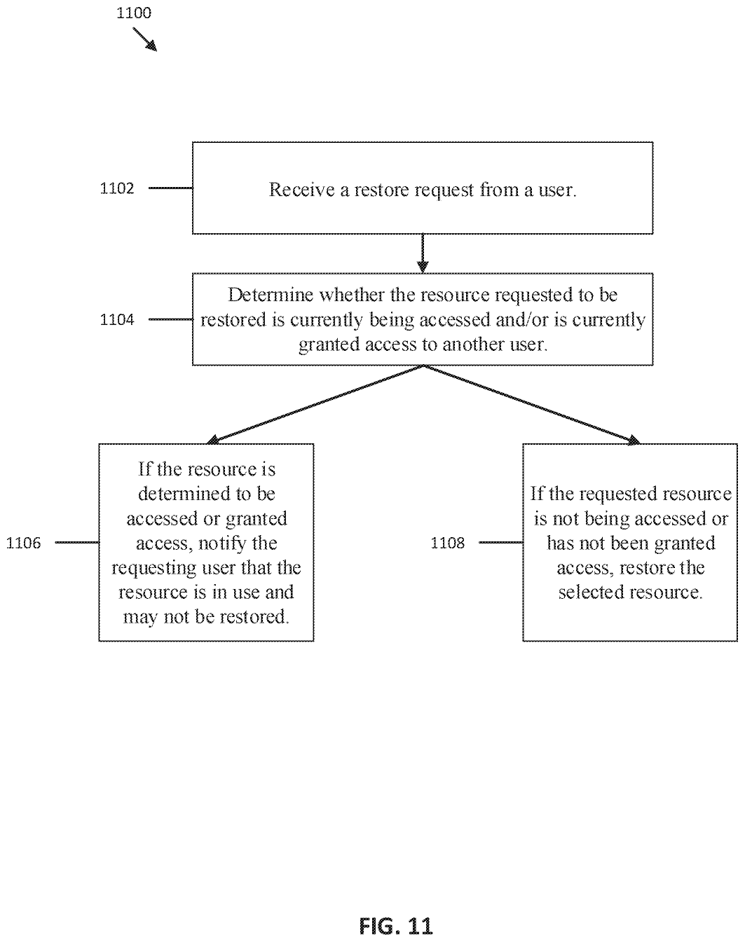

FIG. 11 illustrates a flowchart 1100 for a method of restoring resources, according to an embodiment. At 1102, the system receives a restore request from a user. The system may have previously determined whether the user is authorized to submit a restore request, or the system may determine after the request is received whether the user is authorized to submit a restore request. At 1104, the system determines whether the resource requested to be restored is currently being access and/or is currently been granted access to another user. In other words, the system determines whether the resource requested to be restored is being accessed or could possibly be accessed based on a previously granted access request. At 1106, if the resource is determined to be accessed or granted access, the system notifies the requesting user that the resource is in use and may not be restored. The system may restore a previous version of the requested resource if the resource is currently being accessed. At 1108, if the resource requested to be restored is not being accessed or has not been granted access, the system restores the selected resource to its root folder.

The system may also automatically archive resources. In one embodiment, the system periodically checks if resources folders are being accessed or have been granted access to other users. If a resource meets a predefined condition, such as time frame criteria, size, etc., the system may automatically archive the resource to its predefined root folder. If a predefined condition has been met but the resource is either being accessed or has been granted access to other users, the system may notify an administrator of the circumstances. Alternatively, the system may delay the automatic archiving of the resource until the resource is no longer being accessed or is no longer granted access to another user.

The present system provides an RTDH on resources. The RTDH allows administrators the ability to place an RTDH on file system resources. The RTDHs may be applied globally, by root folder, by child folder, and/or by data classification.

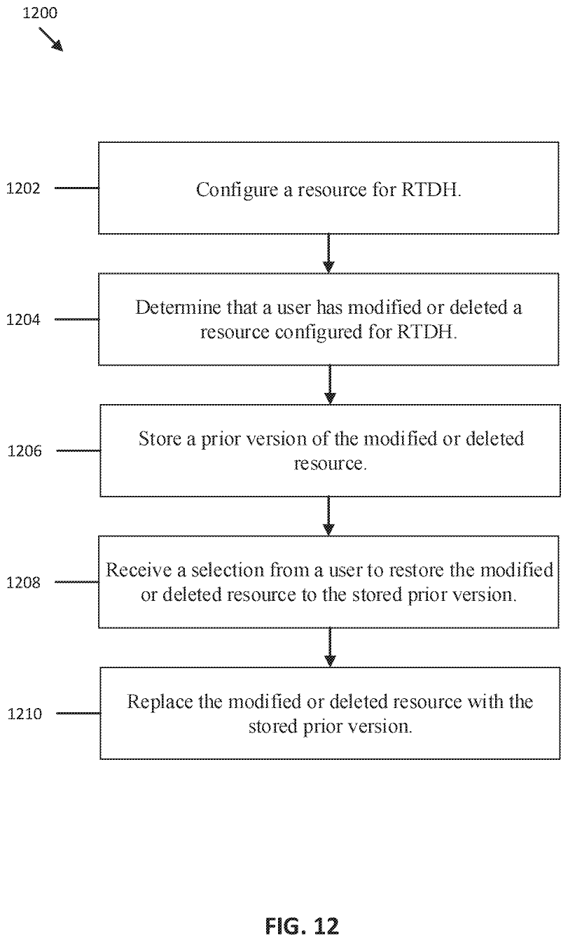

FIG. 12 illustrates a flowchart 1200 for RTDH management, according to an embodiment. At 1202, the system administrator configures a resource for RTDH. The resource may be configured for RTDH by an administrator of the system, or a resource may be configured for RTDH based on predefined conditions, such as a user access, a data size, an amount of time accessed, etc. At 1204, the system detects that a user attempts to modify or delete a resource configured for RTDH and the system will deny the deletion. At 1206, the system stores a prior version of a modified or deleted resource. The prior version of the modified resource is a version that does not include the user modifications. The prior version of the deleted resource is an archive of the deleted resource. At 1208, the system receives a selection from a user to restore the modified or deleted resource to the stored prior version. At 1210, the system replaces the modified or deleted resource with the stored prior version.

The system provides an interface for administrator access. For example, an administrator may access resources through a file explorer system, and the system may provide selection menus for the administrator to place restrictions or authorizations to the resources. Some restrictions and authorizations may include user access authorizations, user archiving authorizations, user restoration authorizations, RTDHs, etc. The administrator may place conditions on the restrictions and authorizations, such as expiration times, group permissions, data classifications, etc. Furthermore, the system provides an administrator with file history information, including user accesses, durations of accesses, times of archiving and restoration, RTDH events, etc.

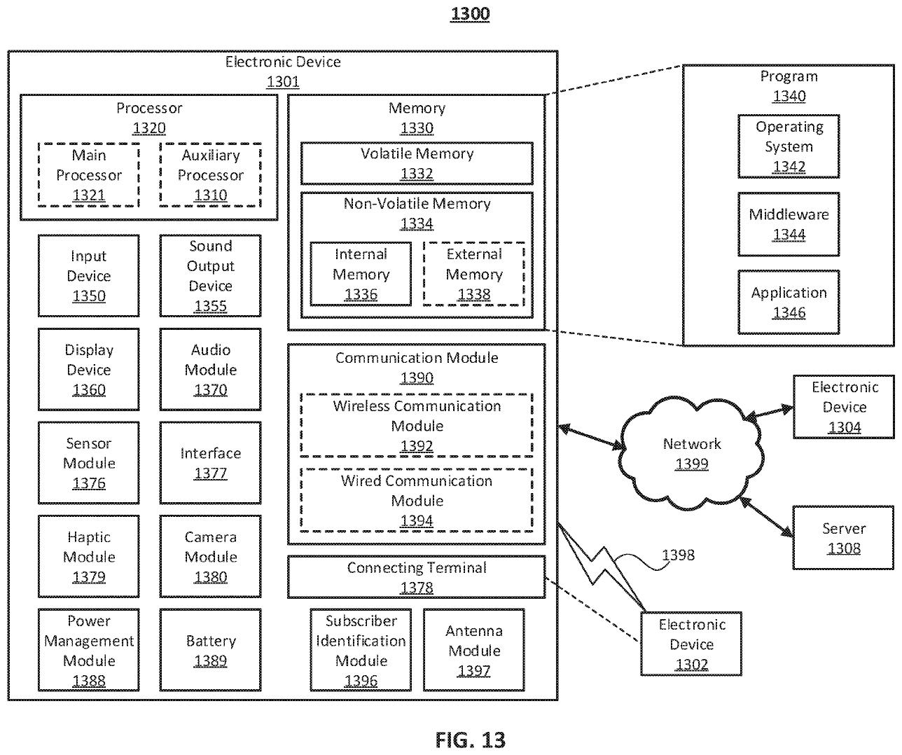

FIG. 13 illustrates a block diagram of an electronic device 1301 in a network environment 1300, according to one embodiment. Referring to FIG. 13, the electronic device 1301 (e.g., a base station with a transceiver) in the network environment 1300 may communicate with an electronic device 1302 via a first network 1398 (e.g., a short-range wireless communication network), or an electronic device 1304 or a server 1308 via a second network 1399 (e.g., a long-range wireless communication network). The electronic device 1301 may communicate with the electronic device 1304 via the server 1308. The electronic device 1301 may include a processor 1320, a memory 1330, an input device 1350, a sound output device 1355, a display device 1360, an audio module 1370, a sensor module 1376, an interface 1377, a haptic module 1379, a camera module 1380, a power management module 1388, a battery 1389, a communication module 1390, a subscriber identification module (SIM) 1396, or an antenna module 1397. In one embodiment, at least one (e.g., the display device 1360 or the camera module 1380) of the components may be omitted from the electronic device 1301, or one or more other components may be added to the electronic device 1301. In one embodiment, some of the components may be implemented as a single integrated circuit (IC). For example, the sensor module 1376 (e.g., a fingerprint sensor, an iris sensor, or an illuminance sensor) may be embedded in the display device 1360 (e.g., a display).

The processor 1320 may execute, for example, software (e.g., a program 1340) to control at least one other component (e.g., a hardware or a software component) of the electronic device 1301 coupled with the processor 1320, and may perform various data processing or computations. As at least part of the data processing or computations, the processor 1320 may load a command or data received from another component (e.g., the sensor module 1376 or the communication module 1390) in volatile memory 1332, process the command or the data stored in the volatile memory 1332, and store resulting data in non-volatile memory 1334. The processor 1320 may include a main processor 1321 (e.g., a central processing unit (CPU) or an application processor (AP)), and an auxiliary processor 1323 (e.g., a graphics processing unit (GPU), an image signal processor (ISP), a sensor hub processor, or a communication processor (CP)) that is operable independently from, or in conjunction with, the main processor 1321. Additionally or alternatively, the auxiliary processor 1323 may be adapted to consume less power than the main processor 1321, or execute a particular function. The auxiliary processor 1323 may be implemented as being separate from, or a part of, the main processor 1321.

The auxiliary processor 1323 may control at least some of the functions or states related to at least one component (e.g., the display device 1360, the sensor module 1376, or the communication module 1390) among the components of the electronic device 1301, instead of the main processor 1321 while the main processor 1321 is in an inactive (e.g., sleep) state, or together with the main processor 1321 while the main processor 1321 is in an active state (e.g., executing an application). According to one embodiment, the auxiliary processor 1323 (e.g., an image signal processor or a communication processor) may be implemented as part of another component (e.g., the camera module 1380 or the communication module 1390) functionally related to the auxiliary processor 1323.

The memory 1330 may store various data used by at least one component (e.g., the processor 1320 or the sensor module 1376) of the electronic device 1301. The various data may include, for example, software (e.g., the program 1340) and input data or output data for a command related thereto. The memory 1330 may include the volatile memory 1332 or the non-volatile memory 1334.

The program 1340 may be stored in the memory 1330 as software, and may include, for example, an operating system (OS) 1342, middleware 1344, or an application 1346.

The input device 1350 may receive a command or data to be used by other component (e.g., the processor 1320) of the electronic device 1301, from the outside (e.g., a user) of the electronic device 1301. The input device 1350 may include, for example, a microphone, a mouse, or a keyboard.

The sound output device 1355 may output sound signals to the outside of the electronic device 1301. The sound output device 1355 may include, for example, a speaker or a receiver. The speaker may be used for general purposes, such as playing multimedia or recording, and the receiver may be used for receiving an incoming call. According to one embodiment, the receiver may be implemented as being separate from, or a part of, the speaker.

The display device 1360 may visually provide information to the outside (e.g., a user) of the electronic device 1301. The display device 1360 may include, for example, a display, a hologram device, or a projector and control circuitry to control a corresponding one of the display, hologram device, and projector. According to one embodiment, the display device 1360 may include touch circuitry adapted to detect a touch, or sensor circuitry (e.g., a pressure sensor) adapted to measure the intensity of force incurred by the touch.

The audio module 1370 may convert a sound into an electrical signal and vice versa. According to one embodiment, the audio module 1370 may obtain the sound via the input device 1350, or output the sound via the sound output device 1355 or a headphone of an external electronic device 1302 directly (e.g., wired) or wirelessly coupled with the electronic device 1301.

The sensor module 1376 may detect an operational state (e.g., power or temperature) of the electronic device 1301 or an environmental state (e.g., a state of a user) external to the electronic device 1301, and then generate an electrical signal or data value corresponding to the detected state. The sensor module 1376 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 1377 may support one or more specified protocols to be used for the electronic device 1301 to be coupled with the external electronic device 1302 directly (e.g., wired) or wirelessly. According to one embodiment, the interface 1377 may include, for example, a high definition multimedia interface (HDMI), a universal serial bus (USB) interface, a secure digital (SD) card interface, or an audio interface.

A connecting terminal 1378 may include a connector via which the electronic device 1301 may be physically connected with the external electronic device 1302. According to one embodiment, the connecting terminal 1378 may include, for example, an HDMI connector, a USB connector, an SD card connector, or an audio connector (e.g., a headphone connector).

The haptic module 1379 may convert an electrical signal into a mechanical stimulus (e.g., a vibration or a movement) or an electrical stimulus which may be recognized by a user via tactile sensation or kinesthetic sensation. According to one embodiment, the haptic module 1379 may include, for example, a motor, a piezoelectric element, or an electrical stimulator.

The camera module 1380 may capture a still image or moving images. According to one embodiment, the camera module 1380 may include one or more lenses, image sensors, image signal processors, or flashes.

The power management module 1388 may manage power supplied to the electronic device 1301. The power management module 1388 may be implemented as at least part of, for example, a power management integrated circuit (PMIC).

The battery 1389 may supply power to at least one component of the electronic device 1301. According to one embodiment, the battery 1389 may include, for example, a primary cell which is not rechargeable, a secondary cell which is rechargeable, or a fuel cell.

The communication module 1390 may support establishing a direct (e.g., wired) communication channel or a wireless communication channel between the electronic device 1301 and the external electronic device (e.g., the electronic device 1302, the electronic device 1304, or the server 1308) and performing communication via the established communication channel. The communication module 1390 may include one or more communication processors that are operable independently from the processor 1320 (e.g., the AP) and supports a direct (e.g., wired) communication or a wireless communication. According to one embodiment, the communication module 1390 may include a wireless communication module 1392 (e.g., a cellular communication module, a short-range wireless communication module, or a global navigation satellite system (GNSS) communication module) or a wired communication module 1394 (e.g., a local area network (LAN) communication module or a power line communication (PLC) module). A corresponding one of these communication modules may communicate with the external electronic device via the first network 1398 (e.g., a short-range communication network, such as Bluetooth™, wireless-fidelity (Wi-Fi) direct, or a standard of the Infrared Data Association (IrDA)) or the second network 1399 (e.g., a long-range communication network, such as a cellular network, the Internet, or a computer network (e.g., LAN or wide area network (WAN)). These various types of communication modules may be implemented as a single component (e.g., a single IC), or may be implemented as multiple components (e.g., multiple ICs) that are separate from each other. The wireless communication module 1392 may identify and authenticate the electronic device 1301 in a communication network, such as the first network 1398 or the second network 1399, using subscriber information (e.g., international mobile subscriber identity (IMSI)) stored in the subscriber identification module 1396.

The antenna module 1397 may transmit or receive a signal or power to or from the outside (e.g., the external electronic device) of the electronic device 1301. According to one embodiment, the antenna module 1397 may include one or more antennas, and, therefrom, at least one antenna appropriate for a communication scheme used in the communication network, such as the first network 1398 or the second network 1399, may be selected, for example, by the communication module 1390 (e.g., the wireless communication module 1392). The signal or the power may then be transmitted or received between the communication module 1390 and the external electronic device via the selected at least one antenna.

At least some of the above-described components may be mutually coupled and communicate signals (e.g., commands or data) therebetween via an inter-peripheral communication scheme (e.g., a bus, a general purpose input and output (GPIO), a serial peripheral interface (SPI), or a mobile industry processor interface (MIPI)).

According to one embodiment, commands or data may be transmitted or received between the electronic device 1301 and the external electronic device 1304 via the server 1308 coupled with the second network 1399. Each of the electronic devices 1302 and 1304 may be a device of a same type as, or a different type, from the electronic device 1301. All or some of operations to be executed at the electronic device 1301 may be executed at one or more of the external electronic devices 1302, 1304, or 1308. For example, if the electronic device 1301 should perform a function or a service automatically, or in response to a request from a user or another device, the electronic device 1301, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 1301. The electronic device 1301 may provide the outcome, with or without further processing of the outcome, as at least part of a reply to the request. To that end, a cloud computing, distributed computing, or client-server computing technology may be used, for example.

One embodiment may be implemented as software (e.g., the program 1340) including one or more instructions that are stored in a storage medium (e.g., internal memory 1336 or external memory 1338) that is readable by a machine (e.g., the electronic device 1301). For example, a processor of the electronic device 1301 may invoke at least one of the one or more instructions stored in the storage medium, and execute it, with or without using one or more other components under the control of the processor. Thus, a machine may be operated to perform at least one function according to the at least one instruction invoked. The one or more instructions may include code generated by a complier or code executable by an interpreter. A machine-readable storage medium may be provided in the form of a non-transitory storage medium. The term “non-transitory” indicates that the storage medium is a tangible device, and does not include a signal (e.g., an electromagnetic wave), but this term does not differentiate between where data is semi-permanently stored in the storage medium and where the data is temporarily stored in the storage medium.

According to one embodiment, a method of the disclosure may be included and provided in a computer program product. The computer program product may be traded as a product between a seller and a buyer. The computer program product may be distributed in the form of a machine-readable storage medium (e.g., a compact disc read only memory (CD-ROM)), or be distributed (e.g., downloaded or uploaded) online via an application store (e.g., Play Store™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to one embodiment, each component (e.g., a module or a program) of the above-described components may include a single entity or multiple entities. One or more of the above-described components may be omitted, or one or more other components may be added. Alternatively or additionally, a plurality of components (e.g., modules or programs) may be integrated into a single component. In this case, the integrated component may still perform one or more functions of each of the plurality of components in the same or similar manner as they are performed by a corresponding one of the plurality of components before the integration. Operations performed by the module, the program, or another component may be carried out sequentially, in parallel, repeatedly, or heuristically, or one or more of the operations may be executed in a different order or omitted, or one or more other operations may be added.

Although certain embodiments of the present disclosure have been described in the detailed description of the present disclosure, the present disclosure may be modified in various forms without departing from the scope of the present disclosure. Thus, the scope of the present disclosure shall not be determined merely based on the described embodiments, but rather determined based on the accompanying claims and equivalents thereto.

What is claimed is:

1. A method for processing an access request, the method comprising:
displaying authorized resources of a user;
receiving an access request for a resource based on a user selection;
prompting the user to confirm the requested access for the resource;
receiving a confirmation from the user for the requested access for the resource; and
applying a corresponding security permission based on the received confirmation.

2. The method of claim 1, further comprising verifying the authorized resources of the user.

3. The method of claim 1, wherein the security permission includes an access duration to the resource.

4. The method of claim 3, further comprising revoking access to the resource when the access duration expires.

5. The method of claim 3, further comprising receiving a request from the user to revoke access to the resource.

6. The method of claim 5, further comprising revoking access to the resource prior to the expiration of the access duration based on the request from the user to revoke access to the resource.

7. The method of claim 1, wherein the received confirmation includes an access duration to the resource.

8. The method of claim 1, wherein displaying authorized resources of the user includes displaying resources to which the user can request access.

9. The method of claim 1, wherein prompting the user includes displaying the resource to which the user requested access and a selection of access durations to the resource.

10. A system for processing an access request, the system comprising:
a memory; and
a processor configured to:
display authorized resources of a user;
receive an access request for a resource based on a user selection;
prompt the user to confirm the requested access for the resource;
receive a confirmation from the user for the requested access for the resource; and
apply a corresponding security permission based on the received confirmation.

11. The system of claim 10, wherein the processor is further configured to verify the authorized resources of the user.

12. The system of claim 10, wherein the security permission includes an access duration to the resource.

13. The system of claim 12, wherein the processor is further configured to revoke access to the resource when the access duration expires.

14. The system of claim 12, wherein the processor is further configured to receive a request from the user to revoke access to the resource.

15. The system of claim 14, wherein the processor is further configured to revoke access to the resource prior to the expiration of the access duration based on the request from the user to revoke access to the resource.

16. The system of claim 10, wherein the received confirmation includes an access duration to the resource.

17. The system of claim 10, wherein the processor is configured to display authorized resources of the user by displaying resources to which the user can request access.

18. The system of claim 10, wherein the processor is configured to prompt the user by displaying the resource to which the user requested access and a selection of access durations to the resource.

19. A method for archiving and restoring resources, the method comprising:
receiving an archiving or restoring request of a resource from a user;
determining whether the resource is being accessed or is granted access to another user;
archiving or restoring the resource when the resource is not being accessed and has not been granted access to another user.

20. A method for real-time data hold (RTDH) of a resource, the method comprising:
configuring a resource for RTDH;
determining that a user has modified or deleted the resource configured for RTDH; and
storing a prior version of the modified or deleted resource.
